(19) United States
(12) Patent Application Publication
(10) Pub. No.: US 2016/0063513 A1
(43) Pub. Date: Mar. 3, 2016

(54) METHOD AND SYSTEM FOR DETERMINING WHEN AND WHAT TIME TO GO SHOPPING

(71) Applicant: MASTERCARD INTERNATIONAL INCORPORATED, Purchase, NY (US)

(72) Inventors: Edward M. Lee, Scarsdale, NY (US); Luckner Polycarpe, Brooklyn, NY (US); Kent Olof Niklas Berntsson, Rye, NY (US)

(21) Appl. No.: 14/471,923

(22) Filed: Aug. 28, 2014

(51) Int. Cl. G06Q 30/02

(52) U.S. Cl. CPC G06Q 30/0201

(57) ABSTRACT

A method and a system are provided for determining when and what time a shopper should go shopping at a merchant. In particular, the present disclosure provides a method and a system for conveying to a shopper various shopping patterns by date and time, and by gender or age group, of a plurality of payment card holders at one or more merchants, based on one or more payment card holder purchase behaviors, to enable the shopper to select a date and time, or gender or age group, for shopping at the one or more merchants. The method and system can be used by shoppers to choose the preferred date/time, or gender or age group of fellow shoppers, to visit a specific merchant.

### RELATED APPLICATION

This application is related to copending U.S. Patent Application Serial No. (0010031USU/4450), filed on an even date herewith, which is incorporated herein by reference in its entirety.

### BACKGROUND OF THE DISCLOSURE

1. Field of the Disclosure

The present disclosure relates to a method and a system for determining when and what time a shopper should go shopping at a merchant. In particular, the present disclosure relates to a method and a system for conveying to a shopper various shopping patterns by date and time, and by gender or age group, of a plurality of payment card holders at one or more merchants, based on one or more payment card holder purchase behaviors, to enable the shopper to select a date and time, or gender or age group, for shopping at the one or more merchants.

2. Description of the Related Art

Most merchants experience times during the day where they have lots of customers in their store, and times when they barely have any. It would be helpful for merchants to be able to predict how many customers that will be in their store at certain times of the day. This information would be useful for the merchant in terms of optimizing resource needs, and would also enable the merchants to run promotions that only apply during “down-times” to drive more customers to their store. For example, if a merchant knows that they do not have many customers between 10:00 am-1:00 pm during weekdays, they could have a 3 hour sale during weekdays to drive more customers to the store during these hours.

Alternatively, it would be useful for customers to know when merchants have the most customers. For some shoppers, there is a strong desire to shop at a merchant site when there is the least amount of fellow shoppers. Such shoppers wish to avoid crowds, or to have a quick checkout experience. Conversely, there are gregarious shoppers who would enjoy shopping at a store when it is the busiest. Such shoppers may also be very selective about the nature of the crowd at the store. Currently, the timing for these preferred day and time for shopping at merchants is based on individual experience or “common sense”.

Accordingly, a need exists for a system and a method that can identify, with as much certainty as possible, what time of the day a merchant is experiencing the most purchase volume, and make this information available to shoppers. This will allow a shopper to choose the preferred date/time to visit a specific merchant. For example, a shopper can choose to go based on the number of shoppers at the store by a given day of the week, hour of the day, as well as the composition (gender and age) of shoppers at the store.

### SUMMARY OF THE DISCLOSURE

The present disclosure provides a method and a system for determining when and what time a shopper should go shopping at a merchant. In particular, the present disclosure relates to a method and a system for conveying to a shopper various shopping patterns by date and time, and by gender or age group, of a plurality of payment card holders at one or more merchants, based on one or more payment card holder purchase behaviors, to enable the shopper to select a date and time, or gender or age group, for shopping at the one or more merchants. The method and system can be used by shoppers to choose the preferred date/time, or gender or age group of fellow shoppers, to visit a specific merchant.

The present disclosure also provides a method that involves retrieving from one or more databases a first set of information comprising payment card transaction information of a plurality of payment card holders, retrieving from one or more databases a second set of information comprising merchant information of one or more merchants, and retrieving from one or more databases a third set of information comprising external information. The method further involves analyzing the first set of information, the second set of information, and the third set of information to identify one or more associations between the payment card transaction information, the merchant information and the external information; identifying one or more payment card holder purchase behaviors based on the one or more associations; and determining shopping patterns by date and time of the plurality of payment card holders at the one or more merchants based on the one or more payment card holder purchase behaviors.

In one embodiment, the method includes conveying to an entity (e.g., shopper) the shopping patterns by date and time of the plurality of payment card holders based on the one or more payment card holder purchase behaviors, to enable the entity (e.g., shopper) to select a date and time for shopping at the one or more merchants.

In another embodiment, the method includes conveying to an entity (e.g., shopper) the shopping patterns by gender or age of the plurality of payment card holders based on the one or more payment card holder purchase behaviors, to enable the entity to select a date and time for shopping at the one or more merchants.

The present disclosure further provides a system that includes one or more databases configured to store a first set of information comprising payment card transaction information of a plurality of payment card holders, one or more databases configured to store a second set of information comprising merchant information of one or more merchants, and one or more databases configured to store a third set of information comprising external information. The system further includes a processor configured to: analyze the first set of information, the second set of information, and the third set of information to identify one or more associations amongst the payment card transaction information, the merchant information and the external information; identify one or more payment card holder purchase behaviors based on the one or more associations; and determine shopping patterns by date and time of the plurality of payment card holders at the one or more merchants based on the one or more payment card holder purchase behaviors.

In one embodiment, the processor is configured to convey to an entity (e.g., shopper) the shopping patterns by date and time of the plurality of payment card holders based on the one or more payment card holder purchase behaviors, to enable the entity to select a date and time for shopping at the one or more merchants.

In another embodiment, the processor is configured to convey to an entity (e.g., shopper) the shopping patterns by gender or age of the plurality of payment card holders based on the one or more payment card holder purchase behaviors, to enable the entity to select a date and time for shopping at the one or more merchants.

The present disclosure yet further provides a method for generating one or more predictive behavioral models. The method includes retrieving from one or more databases a first set of information comprising payment card transaction information of a plurality of payment card holders, retrieving from one or more databases a second set of information comprising merchant information of one or more merchants, and retrieving from one or more databases a third set of information comprising external information. The method further involves analyzing the first set of information, the second set of information, and the third set of information to identify one or more associations amongst the payment card transaction information, the merchant information and the external information; identifying one or more payment card holder purchase behaviors based on the one or more associations; determining shopping patterns by date and time of the plurality of payment card holders at the one or more merchants based on the one or more payment card holder purchase behaviors; and generating one or more predictive behavioral models based on the shopping patterns by date and time of the plurality of payment card holders at the one or more merchants.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 is a block diagram of a portion of a payment card system used in accordance with the present disclosure.

FIG. 4 shows illustrative information types used in the systems and the methods of the present disclosure.

FIG. 5 illustrates an exemplary dataset for the storing, reviewing, and/or analyzing of information used in the systems and the methods of the present disclosure.

FIG. 6 is a block diagram illustrating a method for conveying to a shopper various shopping patterns by date and time, and by gender or age group, of a plurality of payment card holders based on one or more payment card holder purchase behaviors, to enable the shopper to select a date and time, or gender or age group, for shopping at the one or more merchants, in accordance with exemplary embodiments of the present disclosure.

FIG. 7 illustrates an exemplary data set from which shopping patterns are generated in accordance with exemplary embodiments of the present disclosure.

FIG. 8 shows a summary in a half day block of a portion of the data set information in FIG. 7 in accordance with exemplary embodiments of the present disclosure.

FIG. 9 shows a summary in a half day block of a portion of the data set information in FIG. 7 in accordance with exemplary embodiments of the present disclosure.

FIG. 10 is a block diagram illustrating a method for generating one or more predictive behavioral models in accordance with exemplary embodiments of the present disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the one or more databases configured to store the first set of information or from which the first set of information is retrieved, the one or more databases configured to store the second set of information or from which the second set of information is retrieved, and the one or more databases configured to store the third set of information or from which the third set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising payment card transaction information (e.g., payment card holder information, date of payment card transaction, time of payment card transaction, payment card number and transaction amount) of a plurality of payment card holders; retrieve from one or more databases a second set of information comprising merchant information (e.g., merchant name and merchant geolocation) of one or more merchants; and retrieve from one or more databases a third set of information comprising external information (e.g., geographic and demographic information). The first set of information, the second set of information, and the third set of information are analyzed (e.g., algorithmically) to identify one or more associations between the payment card transaction information, the merchant information and the external information. One or more payment card holder purchase behaviors are identified (e.g., algorithmically) based on the one or more associations. Shopping patterns by date and time of the plurality of payment card holders at the one or more merchants are determined (e.g., algorithmically) based on the one or more payment card holder purchase behaviors.

The shopping patterns by date and time of the plurality of payment card holders based on the one or more payment card holder purchase behaviors, are conveyed to an entity (e.g., shopper) to enable the entity to select a date and time for shopping at the one or more merchants. In addition, the shopping patterns by gender or age of the plurality of payment card holders based on the one or more payment card holder purchase behaviors, are conveyed to an entity (e.g., shopper) to enable the entity to select a date and time for shopping at the one or more merchants.

Among many potential uses, the systems and methods described herein can be used to: (1) allow a shopper to choose a preferred date/time to visit a specific merchant, for example, a shopper can choose to go based on the number of shoppers at the store by a given day of the week, hour of the day, as well as the composition (gender and age) of shoppers at the store; (2) help merchants to predict or forecast how many customers will be in their store at certain times of the day; (3) help merchants in terms of optimizing resource needs; and (4) enable merchants to run promotions that only apply during “down-times” to drive more customers to their store. Other uses are possible.

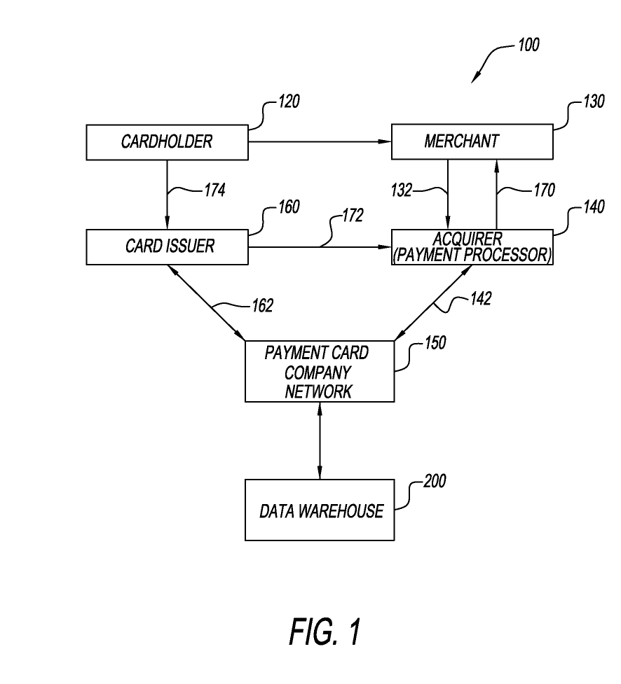

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, merchant category and merchant geolocation for every transaction occurring within payment card network 150. In addition to payment card transaction information and merchant information, data warehouse 200 can also store external information such as demographic information (e.g., gender and age).

In yet another embodiment, data warehouse 200 stores, reviews, and/or analyzes information used in constructing (i) the one or more associations between the payment card transaction information, the merchant information and the external information, (ii) the one or more payment card holder purchase behaviors, (iii) the shopping patterns by date and time of the plurality of payment card holders at the one or more merchants, and (iv) the one or more predictive behavioral models.

In still another embodiment, data warehouse 200 stores, reviews, and/or analyzes information used in creating one or more datasets to store information relating to (i) the one or more associations between the payment card transaction information, the merchant information and the external information, (ii) the one or more payment card holder purchase behaviors, (iii) the shopping patterns by date and time of the plurality of payment card holders at the one or more merchants, and (iv) the one or more predictive behavioral models.

In another embodiment, data warehouse 200 stores, reviews, and/or analyzes information used in developing logic for creating (i) the one or more associations between the payment card transaction information, the merchant information and the external information, (ii) the one or more payment card holder purchase behaviors, (iii) the shopping patterns by date and time of the plurality of payment card holders at the one or more merchants, and (iv) the one or more predictive behavioral models, and applying the logic to a universe of payment card holders to identify one or more payment card holder purchase behaviors of the universe of payment card holders, to determine shopping patterns by date and time of the universe of payment card holders.

In still another embodiment, data warehouse 200 stores, reviews, and/or analyzes information used in quantifying the strength of the one or more associations amongst the payment card transaction information, the merchant information and the external information to identify the strength of the one or more payment card holder purchase behaviors and the shopping patterns by date and time of the plurality of payment card holders at the one or more merchants.

In another embodiment, data warehouse 200 stores, reviews, and/or analyzes information, with respect to the one or more associations amongst the payment card transaction information, the merchant information and the external information, used in assigning attributes to the one or more associations amongst the payment card transaction information, the merchant information, and the external information, in which the attributes are selected from the group consisting of one or more of confidence, time, and frequency.

In yet another embodiment, data warehouse 200 stores, reviews, and/or analyzes information used in identifying one or more payment card holder purchase behaviors; shopping patterns by date and time of the plurality of payment card holders at the one or more merchants; and strength of the one or more associations between the payment card transaction information, the merchant information and the external information.

In another embodiment, data warehouse 200 aggregates the information by payment card holder, merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

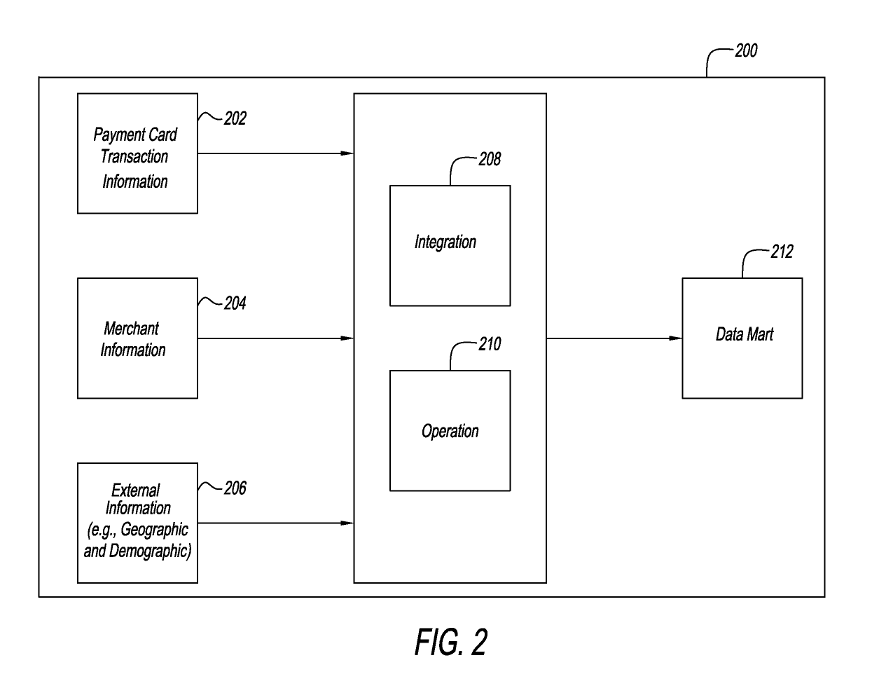

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202, 204 and 206).

The payment card transaction information 202 can include, for example, payment card holder information, and purchasing and payment activities attributable to payment card holders, that can be aggregated by payment card holder, merchant, category and/or location in the data warehouse 200. The payment card transaction information 202 can also include, for example, a transaction identifier, geolocation of payment card transaction, geolocation date on which payment card transaction occurred, geolocation time on which payment card transaction occurred, payment card number, and the like.

The merchant information 204 can include, for example, a merchant name or identifier, geolocation of merchant, merchant category, and the like.

The external information 206 includes, for example, geographic data and demographic data. The external information 206 can include other suitable information that can be useful in identifying one or more associations between the payment card transaction information, the merchant information and the external information; identifying one or more payment card holder purchase behaviors based on the one or more associations; and determining shopping patterns by date and time of the plurality of payment card holders at the one or more merchants based on the one or more payment card holder purchase behaviors.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by merchant, category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas, in turn, can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

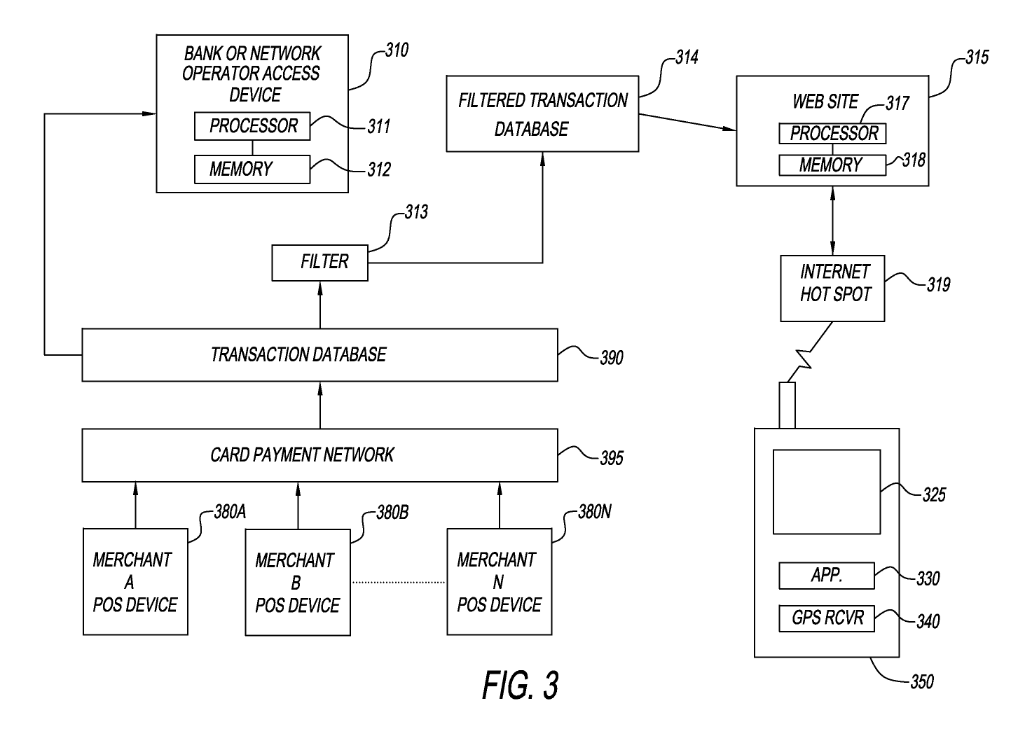

Referring to FIG. 3, a portion of a payment card system used in accordance with the present disclosure is shown. Each merchant that accepts a payment card has on their premises at least one card swiping machine or point of sale device 380, of a type well known in the art, for initiating customer transactions. These point of sale devices 380A, 380B, . . . 380N, generally have a keyboard data pad for entering data when a card's magnetic coding becomes difficult to read, or for the purpose of entering card data resulting from telephone calls during which the customer provides card data by telephone.

Point of sale devices 380A, 380B, . . . 380N are connected by a suitable card payment network 395 (the payment card company network 150 in FIG. 1) to a transaction database 390 associated with or within network 395 that stores information concerning the transactions. The transaction database is included in the data warehouse 200 in FIGS. 1 and 2. An example of such a network 395 is BankNet operated by MasterCard International Incorporated. BankNet is a four party payment network that connects a card issuer, a card holder, merchants, and an acquiring bank, as is well known in the art. In another embodiment, network 395 can be a three party system. In any such embodiment, POS devices 380 do not have direct access to transaction database 390. It is the operator of network 395 that can access transaction database 390.

Information in database 390 can be accessed by a bank or network operator access device 310, such as a computer having a processor 311 and a memory 312. Users of device 310 can be employees of the bank or a payment network operator who are doing research or development work, such as running inquiries, to carry out the reporting and data analysis, including the storing, reviewing, and/or analyzing of information, for the various purposes described above.

Transaction records stored in transaction database 390 include information that is highly confidential and must be maintained confidential to prevent fraud and identity theft. The transaction records stored in transaction database 390 can be anonymized by using a filter 313 that removes confidential information, but retains records concerning all of the other transaction related details discussed above, preferably in real time. Anonymized data is generally necessary for marketing applications. The filtered data is stored in a filtered transaction database 314 that can be accessed as described below. The data in the filtered transaction database 314 can be stored in any type of memory including a hard drive, a flash memory, on a CD, in a RAM, or any other suitable memory.

The following example of an approach to accessing the data involves a mobile telephone. However, it is understood that that there are various other approaches, technologies and pathways that can be used, including direct access by employees of the card issuing bank or a payment network operator.

A mobile telephone 350 having a display 325 can have a series of applications or applets thereon including an applet or application program (hereinafter an application (“APP.”) 330 for use with the embodiment described herein. Mobile telephone 350 can also be equipped with a GPS receiver 340 so that its position is always known.

Mobile telephone 350 can be used to access a website 315 on the Internet, via an Internet connected Wi-Fi hot spot 319 (or by any telephone network, such as a 3G or 4G system, on which mobile telephone 350 communicates), by using application 330. Website 315 is linked to filtered transaction database 314 so that authorized users of website 315 can have access to the data contained therein. These users can be employees of the bank or a network operator who is making inquiries as described above with bank or operator access device 310.

Web site 315 has a processor 317 for assembling data from filtered transaction database 314 for responding to inquiries. A memory 318 associated with web site 315 having a non-transitory computer readable medium, stores computer readable instructions for use by processor 317 in implementing the operation of the disclosed embodiment.

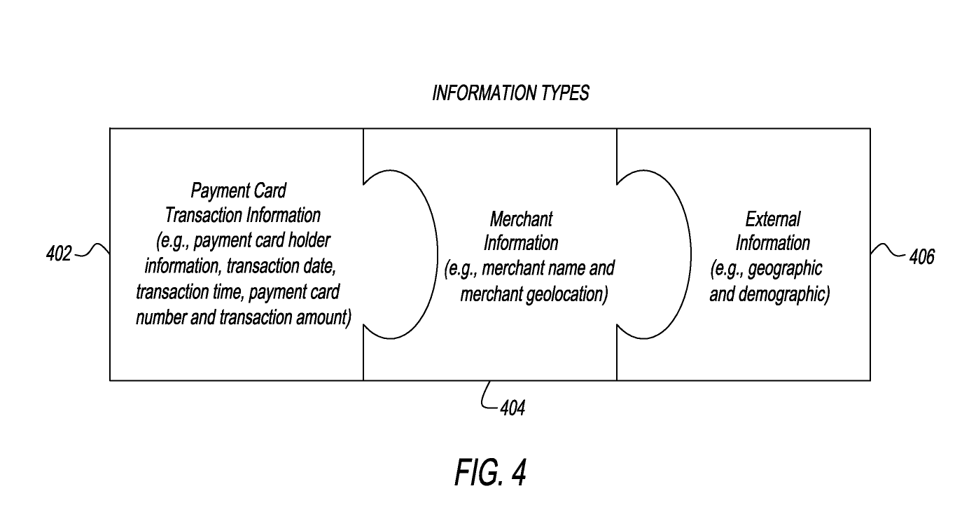

In accordance with the method of this disclosure, information that is stored in one or more databases can be retrieved (e.g., by a processor). FIG. 4 shows illustrative information types used in the systems and methods of this disclosure.

The information can contain, for example, a first set of information 402 that can be retrieved from one or more databases owned or controlled by an entity, for example, a payment card company (part of the payment card company network 150 in FIG. 1). The payment card transaction information 402 can include, for example, payment card transaction information, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, merchant and/or location, transaction date and time, and transaction amount. The transaction payment card information 402 can also include, for example, a transaction identifier, geolocation of payment card transaction, geolocation date on which payment card transaction occurred, geolocation time on which payment card transaction occurred, payment card number, and the like. Information for inclusion in the first set of information can be obtained, for example, from payment card companies known as MasterCard®, Visa®, American Express®, and the like (part of the payment card company network 150 in FIG. 1).

The merchant information 404 can include, for example, merchant name, merchant geography, merchant line of business, merchant category, and the like. The merchant information 404 can also include, for example, a merchant identifier, geolocation of merchant, and the like.

One or more databases are used for storing information of one or more merchants, and merchants belonging to a particular category, e.g., industry category. Illustrative merchant categories are described herein. The merchant categorization, after conveying to a shopper various shopping patterns by date and time, and by gender or age group, of a plurality of payment card holders based on one or more payment card holder purchase behaviors, is useful for a shopper to select a date and time, or gender or age group, for shopping at a merchant, including merchant competitors in the same merchant category. The merchant categorization allows a shopper to assess, not only a target merchant, but also competitors of that merchant, in selecting a date and time, or gender or age group, for shopping at a merchant.

In an embodiment, a merchant category can include a segment of a particular industry. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes of allowing a shopper to assess, not only a target merchant, but also competitors of that merchant, in selecting a date and time, or gender or age group, for shopping at a merchant, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). In one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

The third set of information 406 can include, for example, geographic data, demographic data, and the like. In particular, the third set of information can include, for example, geographic data, geographic areas (e.g., ZIP codes, metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), and the like. The third set of information affords leveraged data sources that can supplement information in the first set of information and the second set of information.

Demographic information can also be used to supplement or leverage the first set of information and the second set of information. Illustrative demographic information includes, for example, gender, age, income, presence of children, education, and the like.

With regard to the sets of information, filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific entry is retrieved from each of the databases.

The overall process flow of this disclosure generally involves data analysis. The data analysis includes constructing the universe of data in a data layout that includes payment card transaction information, merchant information and external information as shown in FIG. 4 and described herein. The analyzing data includes classifying data and/or aggregating data to support payment card holder purchase behavior identifications and shopping pattern determinations that can be made in part using purchase transaction information, merchant information and external information, and creating one or more algorithms for creating the one or more associations amongst the payment card transaction information, the merchant information and the external information, the one or more payment card holder purchase behaviors, the shopping patterns by date and time of the plurality of payment card holders at the one or more merchants, and the one or more predictive behavioral models.

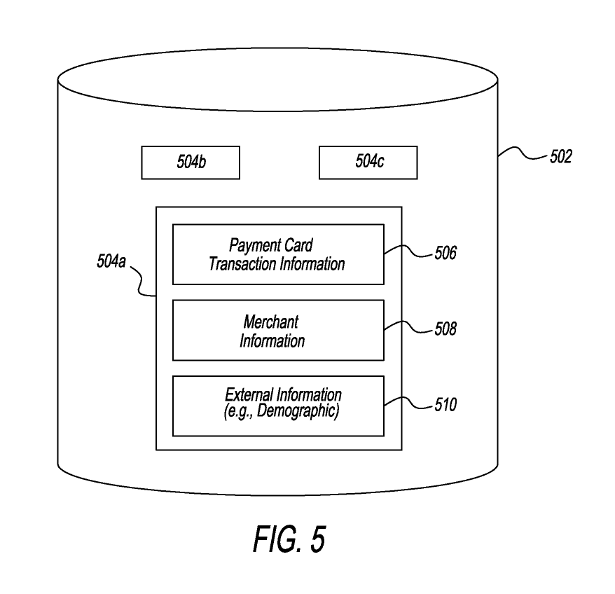

Referring to FIG. 5, an exemplary dataset 502 stores, reviews, and/or analyzes of information used in the systems and methods of this disclosure. The dataset 502 can include a plurality of entries (e.g., entries 504a, 504b, and 504c).

The payment card transaction information 506 includes payment card transactions and actual spending by payment card holders. More specifically, payment card transaction information 506 can include, for example, payment card transaction information, transaction date and time, transaction amount, payment card holder information (e.g., payment card holder account identifier (likely anonymized), payment card holder geography (potentially modeled), payment card holder type (consumer/business), payment card holder demographics, and the like), and purchasing and payment activities attributable to payment card holders, that can be aggregated by payment card holder, merchant and/or location, transaction date and time, and transaction amount. The transaction payment card information 506 can also include, for example, a transaction identifier, geolocation of payment card transaction, geolocation date on which payment card transaction occurred, geolocation time on which payment card transaction occurred, payment card number, and the like. Information for inclusion in the first set of information can be obtained, for example, from payment card companies known as MasterCard®, Visa®, American Express®, and the like (part of the payment card company network 150 in FIG. 1).

The merchant information 508 can include, for example, merchant name, merchant geography, merchant line of business, merchant category, and the like. The merchant information 508 can also include, for example, a merchant identifier, geolocation of merchant, and the like.

The external information 510 includes, for example, geographic data, demographic data, and other suitable information that can be useful in conducting the systems and methods of this disclosure.

Algorithms can be employed to determine formulaic descriptions of the integration of the payment card transaction information 506, merchant information 508 and the external information 510 using any of a variety of known mathematical techniques. These formulas, in turn, can be used to derive or generate one or more analyses and updates using any of a variety of available trend analysis algorithms. For example, these formulas can be used to create the one or more associations amongst the payment card transaction information, the merchant information and the external information, the one or more payment card holder purchase behaviors, the shopping patterns by date and time of the plurality of payment card holders at the one or more merchants, and the one or more predictive behavioral models.

In an embodiment, logic is developed for creating the one or more associations amongst the payment card transaction information, the merchant information and the external information, the one or more payment card holder purchase behaviors, the shopping patterns by date and time of the plurality of payment card holders at the one or more merchants, and the one or more predictive behavioral models. The logic is applied to a universe of payment card holders to identify one or more payment card holder purchase behaviors of the universe of payment card holders, and to determine shopping patterns by date and time of the universe of payment card holders.

In accordance with the method of this disclosure, information that is stored in one or more databases can be retrieved (e.g., by a processor). The information can include, for example, billing activities attributable to the financial transaction processing entity (e.g., a payment card company) and purchasing and payment activities, including date and time, attributable to payment card holders, merchant information, demographic (e.g., age and gender), geographic (e.g., zip code and state or country of residence), and the like. Other illustrative information can include, for example, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive behavioral model is retrieved from each of the databases.

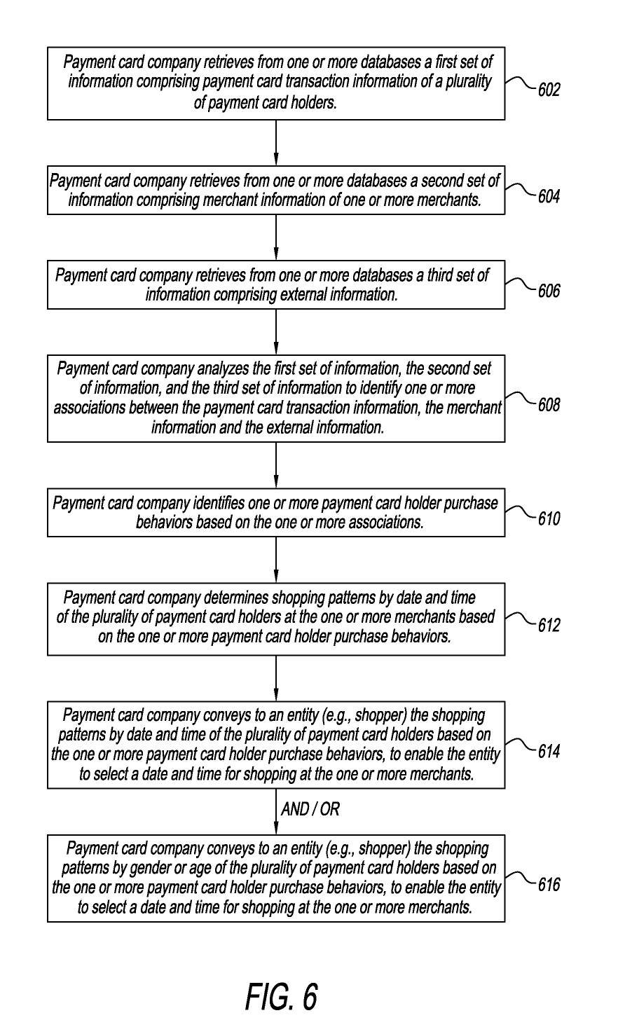

Referring to FIG. 6, the method of this disclosure involves a payment card company (part of the payment card company network 150 in FIG. 1) retrieving from one or more databases a first set of information comprising payment card transaction information of a plurality of payment card holders. In particular, the information at 602 can include, for example, transaction date/time, transaction amount, payment card holder information (e.g., payment card holder account identifier (likely anonymized), payment card holder geography (potentially modeled), payment card holder type (consumer/business), and payment card holder demographics (e.g., gender and age), and the like).

The method of this disclosure also includes the payment card company retrieving from one or more databases a second set of information comprising merchant information of one or more merchants. In particular, the information at 604 can include, for example, merchant information such as merchant name, merchant geography, merchant line of business, merchant category, and the like).

The method of this disclosure also includes the payment card company retrieving from one or more databases a third set of information comprising external information. In particular, the information at 606 can include, for example, geographic and demographic information. Illustrative geographic information includes, for example, geographic data and geographic areas, e.g., ZIP codes, metropolitan areas (metropolitan statistical area (MSA), designated market area (DMA), and the like. Illustrative demographic information includes, for example, gender, age, income, presence of children, education, and the like.

At 608, the payment card company analyzes the first set of information, the second set of information, and the third set of information to identify one or more associations amongst the payment card transaction information, the merchant information and the external information. At 610, the payment card company identifies one or more payment card holder purchase behaviors based on the one or more associations. At 612, the payment card company determines shopping patterns by date and time of the plurality of payment card holders at the one or more merchants based on the one or more payment card holder purchase behaviors

In one embodiment, at 614, the payment card company conveys to an entity (e.g., shopper) the shopping patterns by date and time of the plurality of payment card holders based on the one or more payment card holder purchase behaviors, to enable the entity (e.g., shopper) to select a date and time for shopping at the one or more merchants.

In another embodiment, at 616, the payment card company conveys to an entity (e.g., shopper) the shopping patterns by gender or age of the plurality of payment card holders based on the one or more payment card holder purchase behaviors, to enable the entity to select a date and time for shopping at the one or more merchants.

In an embodiment, the entity (e.g., shopper) provides feedback to the payment card company to enable the payment card company to monitor and track impact of the generated shopping patterns by date and time of the plurality of payment card holders at the one or more merchants. This “closed loop” system allows an entity (e.g., shopper) to measure efficiency of the generated shopping patterns, and make any improvements for the next selection.

One or more algorithms can be employed to determine formulaic descriptions of the assembly of the payment card transaction information, merchant information, and external information, using any of a variety of known mathematical techniques. These formulas in turn can be used to derive or generate one or more associations amongst the payment card transaction information, merchant information and external information, one or more payment card holder purchase behaviors, and shopping patterns by date and time of the plurality of payment card holders at the one or more merchants, using any of a variety of available trend analysis algorithms.

As indicated herein, the systems and the methods of this disclosure utilize standard statistical techniques (e.g., clustering, regression, correlation, segmentation, raking, and the like) to identify one or more associations amongst the payment card transaction information, the merchant information and the external information, and applying the logic to a universe of payment card holders to identify one or more payment card holder purchase behaviors of the universe of payment card holders, and to determine shopping patterns by date and time of the universe of payment card holders. The associations and relationships can be refined by looking at factors such as time, logical geographic breaks, frequency, and the like.

Logic can be created for analyzing the first set of information, the second set of information, and the third set of information to identify one or more associations amongst the payment card transaction information, the merchant information and the external information, and applying the logic to a universe of payment card holders to identify one or more payment card holder purchase behaviors of the universe of payment card holders, and to determine shopping patterns by date and time of the universe of payment card holders, and then quantifying their association or relationship (e.g., confidence quantifier). Once the logic has been created, it can be applied to a universe of payment card holders to identify one or more payment card holder purchase behaviors of the universe of payment card holders, and to determine shopping patterns by date and time of the universe of payment card holders. Attributes (e.g., confidence, time, frequency, and the like) can then be assigned to clusters and/or members of the clusters to make the data useful to potential end users.

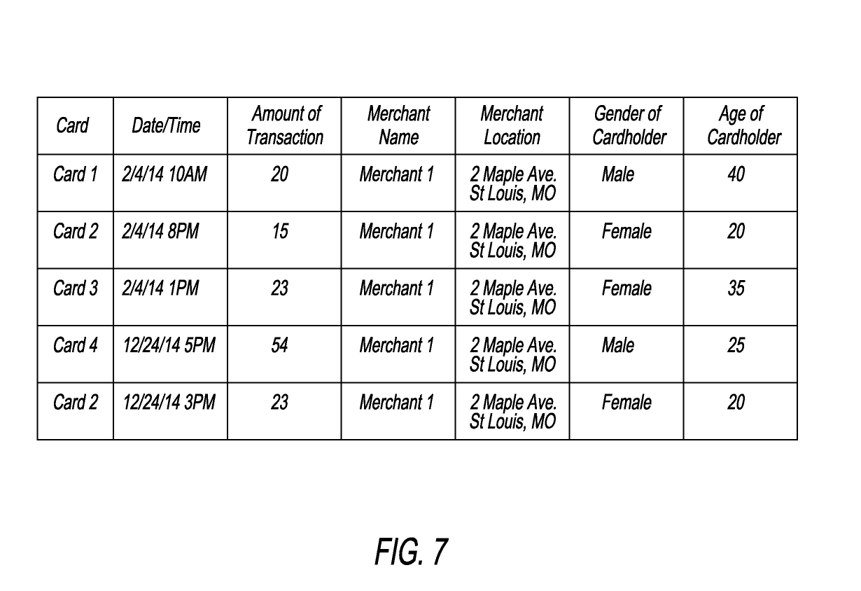

Illustrative shopping patterns generated in accordance with this disclosure are exemplified in FIGS. 7-9. A pre-determined period (e.g., 3 years) of transactional data in the following fields is used: date of payment card transaction, time of payment card transaction, payment card number, merchant name, merchant location, gender of payment card holder, and age of payment card holder.

In a first step, from the payment card transaction level, it can be inferred using statistical methods the opening time and closing time of a merchant's store. This opening time and closing time can then be matched against the opening and closing time for the merchant store found in public information or the internet. In a second step, the pre-determined period of transactional data in the indicated fields will yield differences in days of the week, as well as days in the month, nuisances. When summarizing the data to a specific granularity, an algorithm will endure that there is sufficient data for each merchant location and time. In a third step, the data (e.g., plot, table, graph, and the like) is conveyed to a payment card holder (e.g., shopper) to allow the payment card holder to easily chose his or her desired day and time to visit a particular merchant.

FIG. 7 shows illustrative transactions at a merchant that have been tabulated according to the following areas: payment card number, date of payment card transaction, time of payment card transaction, merchant name, merchant location, gender of payment card holder, and age of payment card holder.

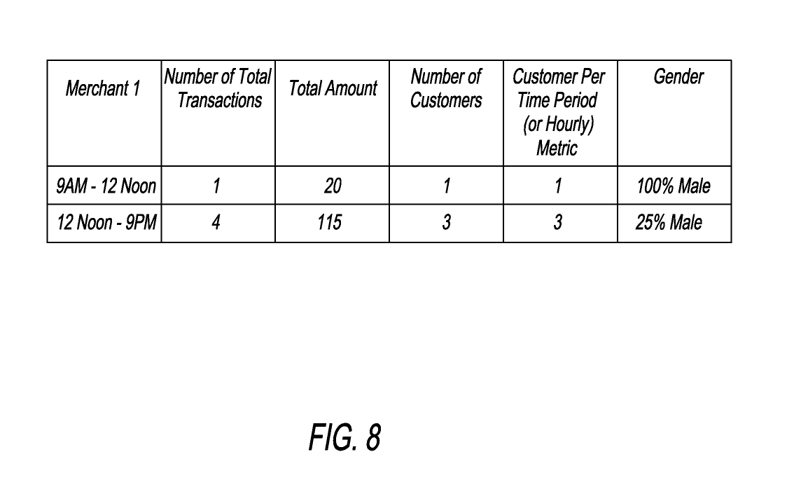

FIG. 8 shows a summary in a half day block of part of the information in FIG. 7. For the periods from 9:00 am-12:00 Noon and from 12:00 Noon-9:00 pm, the summarized information shows the number of total payment card transactions, the total amount of the payment card transactions, the number of payment card holder customers, the payment card holder customer per time period (or hourly) metric, and gender of the payment card holder.

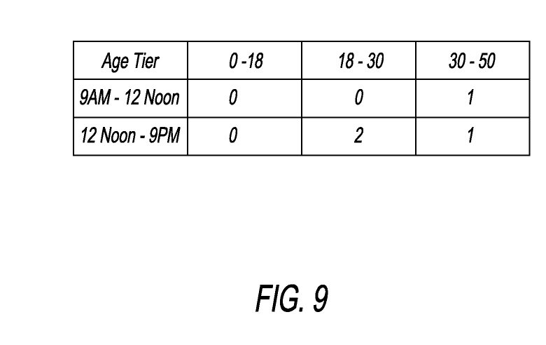

FIG. 9 shows a separate summary in a half day block of part of the information in FIG. 7. For the periods from 9:00 am-12:00 Noon and from 12:00 Noon-9:00 pm, the summarized information shows the age of the payment card holders.

From the data in FIGS. 7-9, shopping patterns by date and time of the payment card holders at the one or more merchants can be determined. For example, for a good non-busy time to go shopping, the morning period would be a better time to go since there are fewer shoppers. Also, for a person who prefers a younger female crowd, the afternoon block would be the best time to go shopping since it would fit her or his demographic preference. The data in FIGS. 7-9 can be extended to different merchants and the time period granularity can be extended to an hourly period to get more precise metrics.

In accordance with this disclosure, one or more predictive behavioral models are generated based at least in part on the first set of information, the second set of information and the third set of information. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models can be based on specific criteria.

Predictive behavioral models are generated from the information obtained from each database. The information is analyzed, extracted and correlated by, for example, a financial transaction processing company (e.g., a payment card company), and can include financial account information, merchant information, external information, performing statistical analysis on financial account information, merchant information and external information, finding associations and correlations between account information, merchant information, external information and payment card holder purchase behaviors and spending patterns, predicting future payment card holder purchase behaviors and shopping patterns by date and time based on account information, merchant information, external information, and the like.

Activities and characteristics attributable to the payment card holders based on the one or more predictive behavioral models are identified. The payment card holders have a propensity to carry out certain activities and to exhibit certain characteristics, based on the one or more predictive behavioral models. The activities and characteristics attributable to the payment card holders and based on the one or more predictive behavioral models are conveyed by the financial transaction processing entity to the entity (e.g., shopper, merchant, and the like) to take appropriate action, for example, a shopper choosing a date/time to visit a specific merchant or a merchant predicting or forecasting how many customers that will be in their store at certain times of the day. This conveyance enables a targeted promotion to be made by the merchant during “down-times” to drive more customers to their store. The transmittal can be performed by any suitable method as will be apparent to persons having skill in the relevant art.

Predictive behavioral models can be defined based on geographical or demographical information, including but not limited to, age, gender, income, marital status, postal code, income, spending propensity, and familial status. In some embodiments, predictive behavioral models can be defined by a plurality of geographical and/or demographical categories. For example, a predictive behavioral model can be defined for any payment card holder who engages in purchasing and spending activity.

Predictive behavioral models can also be based on behavioral variables. For example, the financial transaction processing entity database can store information relating to financial transactions. The information can be used to determine an individual's likeliness to spend at a particular date and time. An individual's likeliness to spend can be represented generally, or with respect to a particular industry, retailer, brand, or any other criteria that can be suitable as will be apparent to persons having skill in the relevant art. An individual's behavior can also be based on additional factors, including but not limited to, time, location, and season. The factors and behaviors identified can vary widely and can be based on the application of the information.

Behavioral variables can also be applied to generated predictive behavioral models based on the attributes of the entities. For example, a predictive behavioral model of specific geographical and demographical attributes can be analyzed for spending behaviors. Results of the analysis can be assigned to the predictive behavioral models.

In an embodiment, the information retrieved from each database can be analyzed to determine behavioral information of the payment card holders. Also, information related to an intention of the payment card holders can be extracted from the behavioral information. The predictive behavioral models can be based upon the behavioral information of the payment card holders and the intent of the payment card holders. In some embodiments, the predictive behavioral models can be capable of predicting behavior and intent in the payment card holders.

In analyzing information to determine behavioral information, intent and other payment card holder attributes are considered. Developing intent of payment card holders involves models that predict specific spend behavior at certain dates and times in the future and desirable spend behaviors.

Predictive behavioral models can equate to purchase behaviors. There can be different degrees of predictive behavioral models with the ultimate behavior being a purchase.

The one or more predictive behavioral models are capable of predicting behavior and intent in the one or more payment card holders. The one or more payment card holders are people and/or businesses. The activities attributable to the one or more payment card holders are purchasing and spending transactions. The characteristics attributable to the one or more payment card holders are demographics and/or geographical characteristics.

A behavioral propensity score can be used for conveying to the entity (e.g., the shopper or merchant) the activities and characteristics attributable to the one or more payment card holders based on the one or more predictive behavioral models. The behavioral propensity score is indicative of a propensity to exhibit a certain behavior.

Potential payment card holders can represent a wide variety of categories and attributes. In one embodiment, potential payment card holder categories can be created based on spending propensity in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like. Each industry can include a plurality of potential payment card holders (e.g., based on location, income groups, and the like).

A financial transaction processing company can analyze the generated predictive behavioral models (e.g., by analyzing the stored data for each entity comprising the predictive behavioral model) for behavioral information (e.g., spend behaviors and propensities). In some embodiments, the behavioral information can be represented by a behavioral propensity score. Behavioral information can be assigned to each corresponding predictive behavioral model.

Predictive behavioral models or behavioral information can be updated or refreshed at a specified time (e.g., on a regular basis or upon request of a party). Updating predictive behavioral models can include updating the entities in each predictive behavioral model with updated demographic data and/or updated financial data and/or updated merchant data. Predictive behavioral models can also be updated by changing the attributes that define each predictive behavioral model, and generating a different set of behaviors. The process for updating behavioral information can depend on the circumstances regarding the need for the information itself.

Although the above methods and processes are disclosed primarily with reference to financial data and spending behaviors, it will be apparent to persons having skill in the relevant art that the predictive behavioral models can be beneficial in a variety of other applications.

The payment card company analyzes the first set of information, second set of information and the third set of information to determine behavioral information of the payment card holders. The payment card company extracts information related to intent of the payment card holders from the behavioral information.

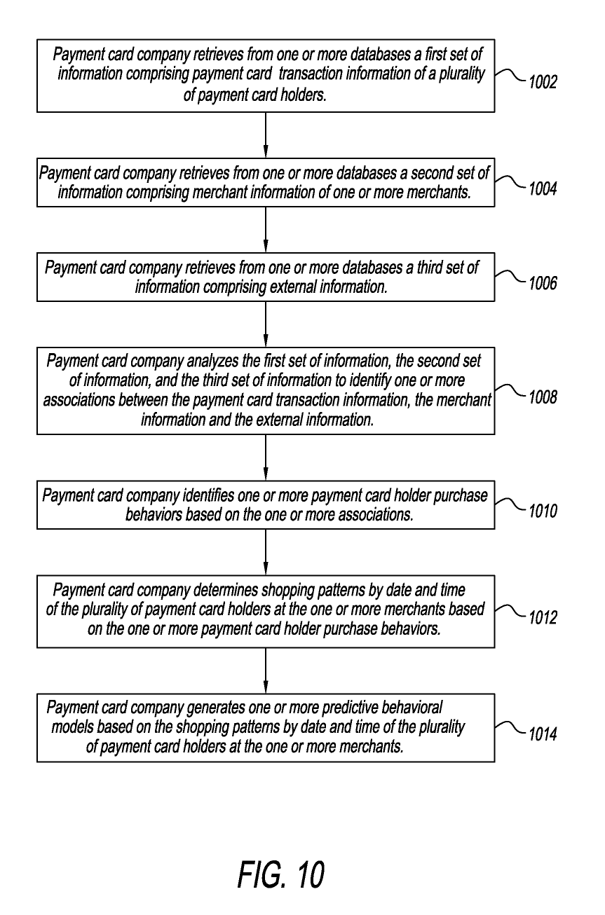

A method for generating one or more predictive behavioral models is an embodiment of this disclosure. Referring to FIG. 10, the method of this disclosure includes a payment card company (part of the payment card company network 150 in FIG. 1) retrieving from one or more databases a first set of information comprising payment card transaction information of a plurality of payment card holders. In particular, the information at 1002 can include, for example, transaction date/time, transaction amount, payment card holder information (e.g., payment card holder account identifier (likely anonymized), payment card holder geography (potentially modeled), payment card holder type (consumer/business), and payment card holder demographics (e.g., gender and age), and the like).

The method for generating one or more predictive behavioral models of this disclosure also includes the payment card company retrieving from one or more databases a second set of information comprising merchant information of one or more merchants. In particular, the information at 1004 can include, for example, merchant information such as merchant name, merchant geography, merchant line of business, merchant category, and the like).

The method for generating one or more predictive behavioral models of this disclosure also includes the payment card company retrieving from one or more databases a third set of information comprising external information. In particular, the information at 1006 can include, for example, geographic and demographic information. Illustrative geographic information includes, for example, geographic data and geographic areas, e.g., ZIP codes, metropolitan areas (metropolitan statistical area (MSA), designated market area (DMA), and the like. Illustrative demographic information includes, for example, gender, age, income, presence of children, education, and the like.

At 1008, the payment card company analyzes the first set of information, the second set of information, and the third set of information to identify one or more associations amongst the payment card transaction information, the merchant information and the external information. At 1010, the payment card company identifies one or more payment card holder purchase behaviors based on the one or more associations. At 1012, the payment card company determines shopping patterns by date and time of the plurality of payment card holders at the one or more merchants based on the one or more payment card holder purchase behaviors

One or more predictive behavioral models are generated at 1014 based on the shopping patterns by date and time of the plurality of payment card holders at the one or more merchants. The one or more payment card holders have a propensity to carry out certain activities at certain times based on the one or more predictive behavioral models.

The payment card company identifies activities and characteristics attributable to payment card holders based on the predictive behavioral models. The activities and characteristics attributable to the payment card holders based on the one or more predictive behavioral models are conveyed by the financial transaction processing entity to the entity (e.g., shopper, merchant, and the like) to take appropriate action, for example, a shopper choosing a date/time to visit a specific merchant or a merchant predicting or forecasting how many customers that will be in their store at certain times of the day. This conveyance enables a targeted promotion to be made by the merchant during “down-times” to drive more customers to their store.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information comprising payment card transaction information of a plurality of payment card holders;
retrieving from one or more databases a second set of information comprising merchant information of one or more merchants;
retrieving from one or more databases a third set of information comprising external information;
analyzing the first set of information, the second set of information, and the third set of information to identify one or more associations between the payment card transaction information, the merchant information and the external information;
identifying one or more payment card holder purchase behaviors based on the one or more associations; and
determining shopping patterns by date and time of the plurality of payment card holders at the one or more merchants based on the one or more payment card holder purchase behaviors.

2. The method of claim 1, further comprising:
conveying to an entity the shopping patterns by date and time of the plurality of payment card holders based on the one or more payment card holder purchase behaviors, to enable the entity to select a date and time for shopping at the one or more merchants.

3. The method of claim 1, further comprising:
conveying to an entity the shopping patterns by gender or age of the plurality of payment card holders based on the one or more payment card holder purchase behaviors, to enable the entity to select a date and time for shopping at the one or more merchants.

4. The method of claim 3, wherein the entity is a payment card holder, and wherein the conveying to the payment card holder is carried out by e-mails, text messages, phone calls, television or internet.

5. The method of claim 1, wherein the external information comprises geographic data and demographic data.

6. The method of claim 1, wherein the payment card transaction information comprises at least date of payment card transaction, time of payment card transaction, and payment card number, wherein the merchant information comprises at least merchant name and merchant geolocation, and wherein the external information comprises at least gender of payment card holder and age of payment card holder.

7. The method of claim 1, further comprising algorithmically analyzing the first set of information, the second set of information, and the third set of information to identify one or more associations amongst the payment card transaction information, the merchant information and the external information; algorithmically identifying one or more payment card holder purchase behaviors based on the one or more associations; and algorithmically determining shopping patterns by date and time of the plurality of payment card holders at the one or more merchants based on the one or more payment card holder purchase behaviors.

8. The method of claim 1, further comprising creating one or more datasets to store information relating to the one or more associations amongst the payment card transaction information, the merchant information and the external information, the one or more payment card holder purchase behaviors, and the shopping patterns by date and time of the plurality of payment card holders at the one or more merchants.

9. The method of claim 1, further comprising developing logic for analyzing the first set of information, the second set of information, and the third set of information to identify one or more associations amongst the payment card transaction information, the merchant information and the external information, and applying the logic to a universe of payment card holders to identify one or more payment card holder purchase behaviors of the universe of payment card holders, and to determine shopping patterns by date and time of the universe of payment card holders.

10. The method of claim 9, further comprising quantifying the strength of the one or more associations amongst the payment card transaction information, the merchant information and the external information, to identify the strength of the one or more payment card holder purchase behaviors and the shopping patterns by date and time of the plurality of payment card holders at the one or more merchants.

11. The method of claim 9, further comprising assigning attributes to the one or more associations amongst the payment card transaction information, the merchant information, and the external information, wherein the attributes are selected from the group consisting of one or more of confidence, time, and frequency.

12. The method of claim 1, wherein the one or more associations amongst the payment card transaction information, the merchant information, and the external information, the one or more payment card holder purchase behaviors, and the shopping patterns by date and time of the plurality of payment card holders are constructed by statistical analysis selected from the group consisting of clustering, regression, correlation, segmentation, and raking.

13. The method of claim 1, further comprising algorithmically constructing the one or more associations amongst the payment card transaction information, the merchant information, and the external information, the one or more payment card holder purchase behaviors, and the shopping patterns by date and time of the plurality of payment card holders.

14. A system comprising:
one or more databases configured to store a first set of information comprising payment card transaction information of a plurality of payment card holders;
one or more databases configured to store a second set of information comprising merchant information of one or more merchants;
one or more databases configured to store a third set of information comprising external information;
a processor configured to:
analyze the first set of information, the second set of information, and the third set of information to identify one or more associations amongst the payment card transaction information, the merchant information and the external information;
identify one or more payment card holder purchase behaviors based on the one or more associations; and
determine shopping patterns by date and time of the plurality of payment card holders at the one or more merchants based on the one or more payment card holder purchase behaviors.

15. The system of claim 14, wherein the processor is configured to:
convey to an entity the shopping patterns either (a) by date and time of the plurality of payment card holders based on the one or more payment card holder purchase behaviors, to enable the entity to select a date and time for shopping at the one or more merchants, or (b) by gender or age of the plurality of payment card holders based on the one or more payment card holder purchase behaviors, to enable the entity to select a date and time for shopping at the one or more merchants.

16. The system of claim 15, wherein the entity is a payment card holder, and wherein the conveying to the payment card holder is carried out by e-mails, text messages, phone calls, television or internet.

17. The system of claim 14, wherein the payment card transaction information comprises at least date of payment card transaction, time of payment card transaction, and payment card number, wherein the merchant information comprises at least merchant name and merchant geolocation, and wherein the external information comprises at least gender of payment card holder and age of payment card holder.

18. The system of claim 14, wherein the processor is configured to perform one or more functions selected from the group consisting of: (a) algorithmically analyze the first set of information, the second set of information, and the third set of information to identify one or more associations between the payment card transaction information, the merchant information and the external information; algorithmically identify one or more payment card holder purchase behaviors based on the one or more associations; and algorithmically determine shopping patterns by date and time of the plurality of payment card holders at the one or more merchants based on the one or more payment card holder purchase behaviors; (b) create one or more datasets to store information relating to the one or more associations between the payment card transaction information, the merchant information and the external information, the one or more payment card holder purchase behaviors, and the shopping patterns by date and time of the plurality of payment card holders at the one or more merchants; (c) to develop logic for analyzing the first set of information, the second set of information, and the third set of information to identify one or more associations between the payment card transaction information, the merchant information and the external information, and applying the logic to a universe of payment card holders to identify one or more payment card holder purchase behaviors of the universe of payment card holders, and to determine shopping patterns by date and time of the universe of payment card holders; (d) quantify the strength of the one or more associations between the payment card transaction information, the merchant information and the external information to identify the strength of the one or more payment card holder purchase behaviors and the shopping patterns by date and time of the plurality of payment card holders at the one or more merchants; (e) assign attributes to the one or more associations between the payment card transaction information, the merchant information, and the external information, wherein the attributes are selected from the group consisting of one or more of confidence, time, and frequency; and (f) algorithmically construct the one or more associations between the payment card transaction information, the merchant information, and the external information, the one or more payment card holder purchase behaviors, and the shopping patterns by date and time of the plurality of payment card holders

19. The system of claim 14, wherein the one or more associations amongst the payment card transaction information, the merchant information, and the external information, the one or more payment card holder purchase behaviors, and the shopping patterns by date and time of the plurality of payment card holders are constructed by statistical analysis selected from the group consisting of clustering, regression, correlation, segmentation, and raking.

20. A method for generating one or more predictive behavioral models, the method comprising:
retrieving from one or more databases a first set of information comprising payment card transaction information of a plurality of payment card holders;
retrieving from one or more databases a second set of information comprising merchant information of one or more merchants;
retrieving from one or more databases a third set of information comprising external information;
analyzing the first set of information, the second set of information, and the third set of information to identify one or more associations between the payment card transaction information, the merchant information and the external information;
identifying one or more payment card holder purchase behaviors based on the one or more associations;
determining shopping patterns by date and time of the plurality of payment card holders at the one or more merchants based on the one or more payment card holder purchase behaviors; and
generating one or more predictive behavioral models based on the shopping patterns by date and time of the plurality of payment card holders at the one or more merchants.
